(19) United States
(12) Patent Application Publication
(10) Pub. No.: US 2026/0073902 A1
(43) Pub. Date: Mar. 12, 2026

(54) AUDIO PROCESSING SYSTEM AND VIRTUAL REALITY WEARABLE DEVICE HAVING AUDIO PROCESSING MECHANISM

(71) Applicant: C-MEDIA ELECTRONICS INC., TAIPEI CITY (TW)

(72) Inventors: CHI-CHEN CHENG, TAIPEI CITY (TW); JEI-WEN TENG, Keelung City (TW)

(21) Appl. No.: 19/189,285

(22) Filed: Apr. 25, 2025

(30) Foreign Application Priority Data
Sep. 11, 2024 (TW) 113134325

(51) Int. Cl. G10K 15/08; G06F 3/16

(52) U.S. Cl. CPC G10K 15/08; G06F 3/165

(57) ABSTRACT

An audio processing system and a virtual reality wearable device having an audio processing mechanism are provided. The virtual reality wearable device includes a virtual reality wearable component and the audio processing system. When the virtual reality wearable component plays a song signal and a user that wears the virtual reality wearable device generates voice, the virtual reality wearable component records a sound signal. The audio processing system removes howling sound from the voice signal. The virtual reality wearable component plays the sound signal from which the howling sound is removed.

### CROSS-REFERENCE TO RELATED PATENT APPLICATION

This application claims the benefit of priority to Taiwan Patent Application No. 113134325, filed on Sep. 11, 2024. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to an audio processing system, and more particularly to an audio processing system and a virtual reality wearable device having an audio processing mechanism.

### BACKGROUND OF THE DISCLOSURE

Conventional virtual reality (VR) head-mounted devices on the market have singing software installed thereon. However, a recording delay of built-in microphones of the conventional VR head-mounted devices is much larger than that of headsets. Therefore, an in-ear-monitor (IEM) effect realized by the conventional VR head-mounted devices is much poorer than that implemented by the headsets. When a user wears the conventional VR head-mounted device and uses their voice for singing a song according to a song signal played by the conventional VR head-mounted device, the conventional VR head-mounted device delays the playing of an audio signal that includes the recorded song signal, the recorded voice, and any howling sound, which can affect the user when singing the song. An in-ear-monitor effect is unable to be realized by the built-in microphone and a built-in speaker of the conventional VR head-mounted device. Therefore, the user must wear both the conventional VR head-mounted device and the headset for providing the in-ear-monitor effect, which causes inconvenience to the user. Furthermore, the headset must be additionally purchased by the user, such that hardware cost is increased.

Furthermore, the conventional VR head-mounted device does not, based on changes in environmental atmosphere in a virtual image displayed on a display screen of the conventional VR head-mounted device, modulate the audio signal that is played. That is, the conventional VR head-mounted device does not have an audio modulation function for the audio signal that is played. Therefore, when the user wears the conventional VR head-mounted device and watches various virtual scenes displayed on the display screen of the conventional VR head-mounted device, the conventional VR head-mounted device provides a poor experience for the user due to the lack of audio modulation.

### SUMMARY OF THE DISCLOSURE

In response to the above-referenced technical inadequacies, the present disclosure provides an audio processing system. The audio processing system is applicable to a virtual reality wearable component. The audio processing system includes an audio play control component. The audio play control component is connected to the virtual reality wearable component. The audio play control component is configured to control the virtual reality wearable component to play a song signal. The audio play control component is configured to control the virtual reality wearable component to record a sound signal when the song signal is played and a user generates a voice according to the song signal. The audio play control component is configured to remove any howling sound from the sound signal to output an audio signal. The virtual reality wearable component is configured to play the audio signal from the audio play control component.

In order to solve the above-mentioned problems, one of the technical aspects adopted by the present disclosure is to provide a virtual reality wearable device having an audio processing mechanism. In the present disclosure, the virtual reality wearable device having the audio processing mechanism includes a virtual reality wearable component and the audio processing system as described above.

As described above, the present disclosure provides the audio processing system and the virtual reality wearable device having the audio processing mechanism. The virtual reality wearable device of the present disclosure includes the virtual reality wearable component (such as virtual reality glasses) and the audio processing system. The audio processing system of the present disclosure is capable of removing the howling sound that is noise from the sound signal for the user. When the user wears the virtual reality wearable device, the virtual reality wearable component plays the sound signal from which the howling sound is removed to the user, so that the user is able to sing the song without noise interruption of the howling sound. Therefore, the virtual reality wearable device of the present disclosure is capable of achieving an in-ear-monitor (IEM) effect that is unable to be realized by conventional virtual reality wearable devices. Therefore, the user only needs to wear the virtual reality wearable device of the present disclosure, but not additional headsets or other hardware components.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic diagram of a user wearing a virtual reality wearable device having an audio processing mechanism according to a first embodiment of the present disclosure;

FIG. 2 is a block diagram of an audio processing system and the virtual reality wearable device having the audio processing mechanism according to the first embodiment of the present disclosure;

FIG. 3 is a schematic diagram of the user that wears a virtual reality wearable device having an audio processing mechanism and watches a virtual reality image displayed on a display component of a virtual reality wearable component according to a second embodiment of the present disclosure;

FIG. 4 is a block diagram of an audio processing system and a virtual reality wearable device having an audio processing mechanism according to a third embodiment of the present disclosure;

FIG. 5 is a block diagram of an audio processing system and a virtual reality wearable device having an audio processing mechanism according to a fourth embodiment of the present disclosure;

FIG. 6 is a block diagram of an audio processing module of a virtual reality wearable device having an audio processing mechanism according to a fifth embodiment of the present disclosure;

FIG. 7 is a flowchart diagram of the virtual reality wearable device having the audio processing mechanism according to the fifth embodiment of the present disclosure;

FIG. 8 is a schematic diagram of waveform modulation of a sound signal generated by the virtual reality wearable device having the audio processing mechanism according to a sixth embodiment of the present disclosure; and

FIG. 9 is a schematic diagram of waveform modulation of a sound signal generated by the virtual reality wearable device having the audio processing mechanism according to a seventh embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

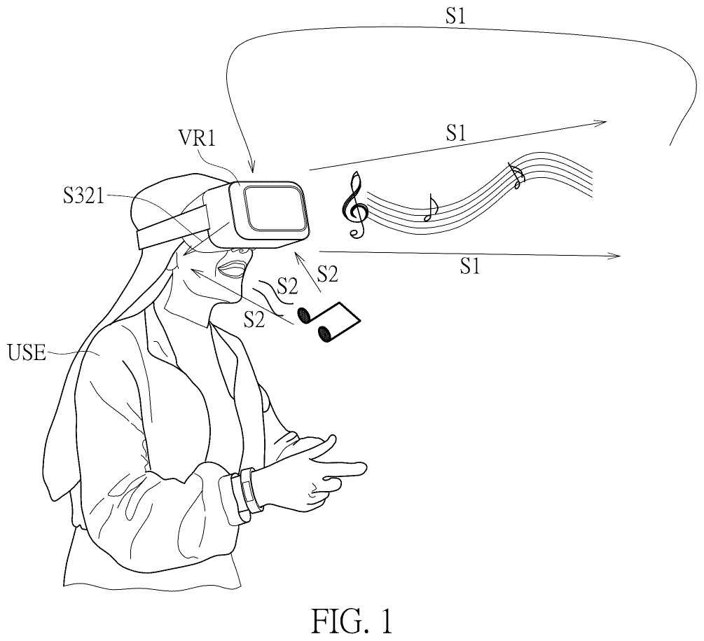

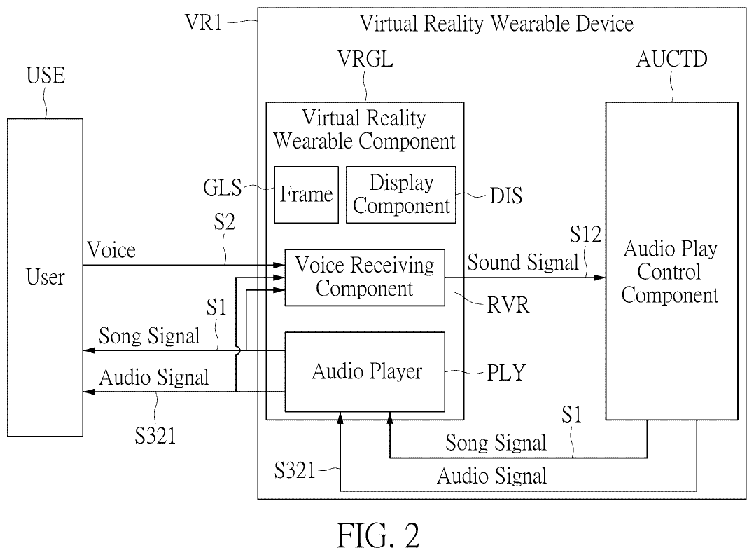

Reference is made to FIG. 1 and FIG. 2, in which FIG. 1 is a schematic diagram of a user wearing a virtual reality wearable device having an audio processing mechanism according to a first embodiment of the present disclosure, and FIG. 2 is a block diagram of an audio processing system and the virtual reality wearable device having the audio processing mechanism according to the first embodiment of the present disclosure.

In the first embodiment of the present disclosure, a virtual reality wearable device VR1 having the audio processing mechanism includes a virtual reality wearable component VRGL and an audio play control component AUCTD. The audio processing system includes the audio play control component AUCTD.

The virtual reality wearable component VRGL described herein may be virtual reality glasses, virtual reality helmets, or other types of components such as accessories having virtual reality functions. For convenience of explanation, the virtual reality wearable component VRGL is described as the virtual reality glasses herein, but the present disclosure is not limited thereto.

The virtual reality wearable component VRGL includes a glasses frame GLS, a display component DIS, a voice receiving component RVR and an audio player PLY. The display component DIS, the voice receiving component RVR and the audio player PLY are disposed on the glasses frame GLS of the virtual reality wearable component VRGL. For example, the voice receiving component RVR includes a microphone and the audio player PLY includes a speaker, but the present disclosure is not limited thereto.

The audio play control component AUCTD is connected to the voice receiving component RVR and the audio player PLY of the virtual reality wearable component VRGL.

The audio play control component AUCTD outputs a song signal S1 to the audio player PLY of the virtual reality wearable component VRGL, and controls the audio player PLY to play the song signal S1. The song signal S1 is a sound signal. The audio player PLY of the virtual reality wearable component VRGL plays the song signal S1, and a user USE generates a voice S2 according to the song signal S1. At this time, the audio play control component AUCTD controls the voice receiving component RVR of the virtual reality wearable component VRGL to record a sound signal S12. The sound signal S12 includes the song signal S1, the voice S2, an audio signal S321, sound in an environment and so on. A time point at which the voice receiving component RVR starts recording the sound signal S12 depends on practical requirements, but the present disclosure is not limited thereto.

It is worth noting that, the audio play control component AUCTD receives the sound signal S12 from the voice receiving component RVR, and performs an anti-howling sound algorithm on the sound signal S12 for removing howling sound from the sound signal S12. The anti-howling sound algorithm described herein includes codes for removing the howling sound from the sound signal S12. However, these codes included in the anti-howling sound algorithm depend on practical requirements, and the present disclosure is not limited thereto.

The audio play control component AUCTD generates the audio signal S321 according to the sound signal S12 from which the howling sound is removed. The audio play control component AUCTD outputs the audio signal S321 to the audio player PLY of the virtual reality wearable component VRGL. Therefore, when the user USE wears the virtual reality wearable device VR1 playing the audio signal S321, the user does not hear the howling sound.

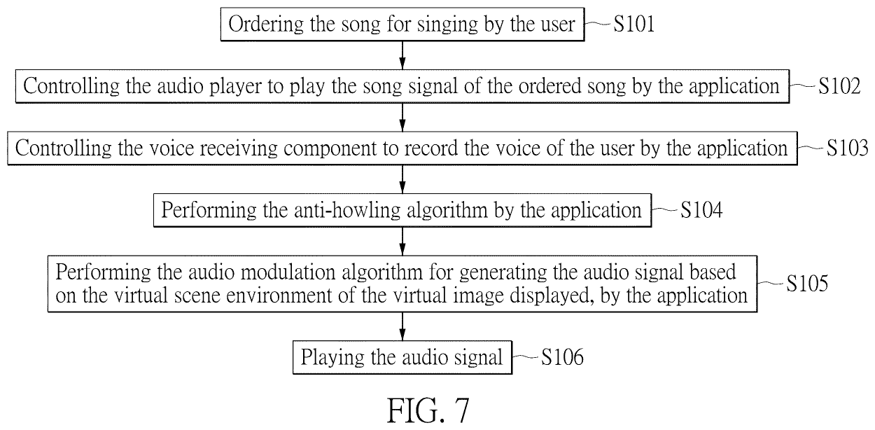

If necessary, after the howling sound is removed, the audio play control component AUCTD of the present disclosure may perform an audio modulation algorithm for adjusting the sound signal S12 according to various factors such as atmosphere of a virtual scene environment in a virtual image displayed on the display component DIS of the virtual reality wearable device VR1 (in steps S104 and S105 of FIG. 7), as described in detail as follows.

For convenience of explanation, the audio play control component AUCTD may use the sound signal S12 from which the howling sound is removed as a main audio signal.

The audio play control component AUCTD may generate an echo signal and a reverberation signal based on the main audio signal, and output the audio signal S321 according to the main audio signal, the echo signal and the reverberation signal.

Alternatively, the audio play control component AUCTD may generate the echo signal and the reverberation signal based on the main audio signal, multiply the main audio signal by a main audio gain to form a main audio modulated signal, and output the audio signal S321 according to the main audio modulated signal, the echo signal and the reverberation signal.

Alternatively, the audio play control component AUCTD may generate the echo signal and the reverberation signal based on the main audio signal, multiply the main audio signal by the main audio gain to form the main audio modulated signal, multiply the echo signal by an echo gain to form an echo modulated signal, and output the audio signal S321 according to the main audio modulated signal, the echo modulated signal and the reverberation signal.

Alternatively, the audio play control component AUCTD may generate the echo signal and the reverberation signal based on the main audio signal, multiply the main audio signal by the main audio gain to form the main audio modulated signal, multiply the echo signal by the echo gain to form the echo modulated signal, multiply the reverberation signal by a reverberation gain to form a reverberation modulated signal, and output the audio signal S321 according to the main audio modulated signal, the echo modulated signal and the reverberation modulated signal.

The audio play control component AUCTD may synthesize the main audio modulated signal, the echo modulated signal and the reverberation modulated signal to form an audio synthesized signal, and multiply the audio synthesized signal by an audio entire gain to output the audio signal S321.

The main audio gain, the echo gain and the reverberation gain may depend on information of the atmosphere of the virtual scene environment of the virtual image displayed on the display component DIS of the virtual reality wearable device VR1. For example, both of the main audio gain and the echo gain are equal to 0, or are smaller than or equal to 0.5 for reducing sound volume of both of the main audio signal and the echo signal.

It is worth noting that, delay occurs in the process of recording the sound signal S12 by the voice receiving component RVR of the virtual reality wearable device VR1 to play the audio signal S321 by the audio player PLY. Therefore, in the audio processing system of the present disclosure, the audio player PLY and the voice receiving component RVR are open built-in components. For example, the audio player PLY is an open built-in speaker and the voice receiving component RVR is an open built-in microphone. When the user USE wears the virtual reality wearable device VR1 of the present disclosure, the virtual reality wearable device VR1 does not cover ears of the user USE and the voice generated by the user USE travels through air to the ears of the user USE. The user USE hears his own voice from the air rather than from the virtual reality wearable device VR1. Therefore, the virtual reality wearable device VR1 sets the main audio gain of the main audio signal to be a zero value, which equivalently removes the main audio signal.

That is, when the user USE wears the virtual reality wearable device VR1 of the present disclosure, the user USE hears the modulated echo and the modulated reverberation in the audio signal S321 played by the virtual reality wearable device VR1, and hears his own voice from the air.

If necessary, the audio play control component AUCTD maintains sound volume of the audio signal S321 played by the audio player PLY of the virtual reality wearable component VRGL at a preset value.

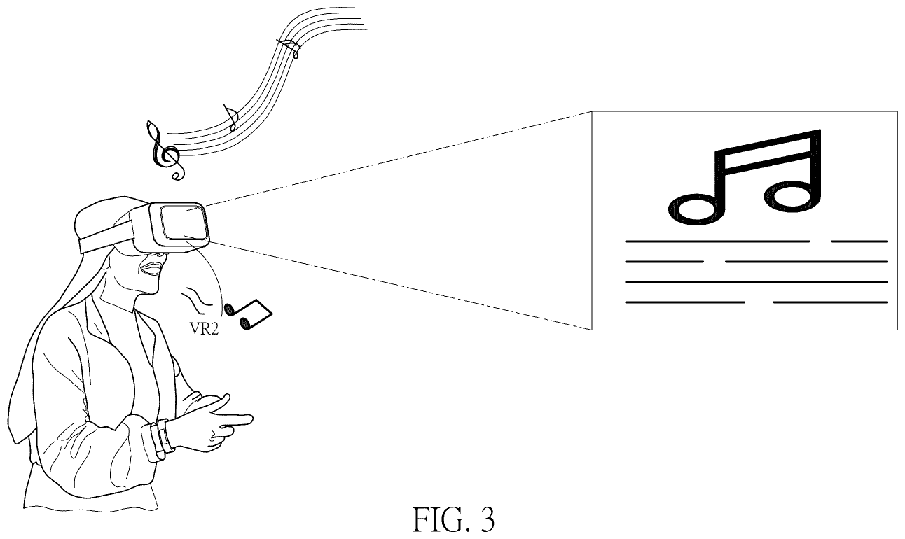

Reference is made to FIG. 3, which is a schematic diagram of a user that wears a virtual reality wearable device having an audio processing mechanism and watches a virtual reality image displayed on a display component of a virtual reality wearable component according to a second embodiment of the present disclosure.

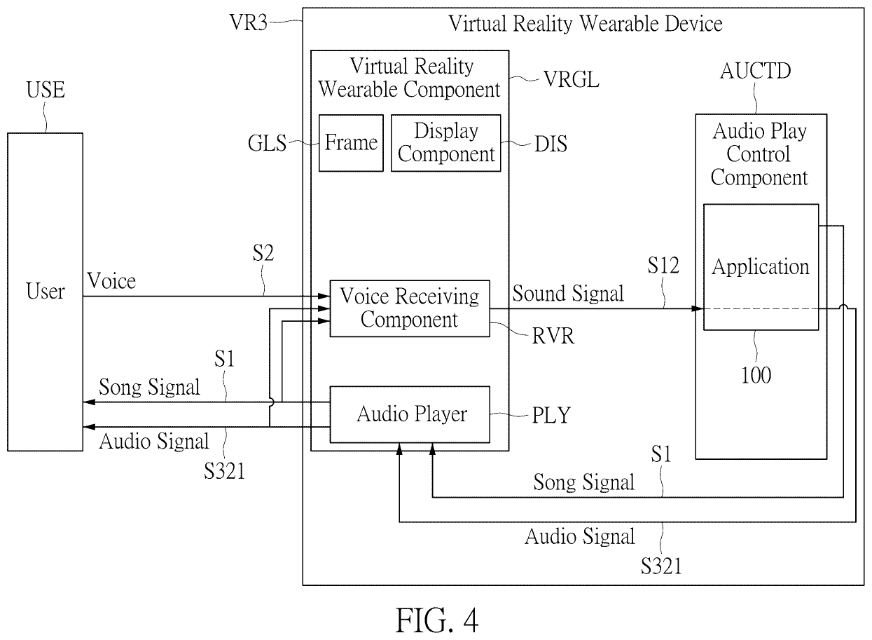

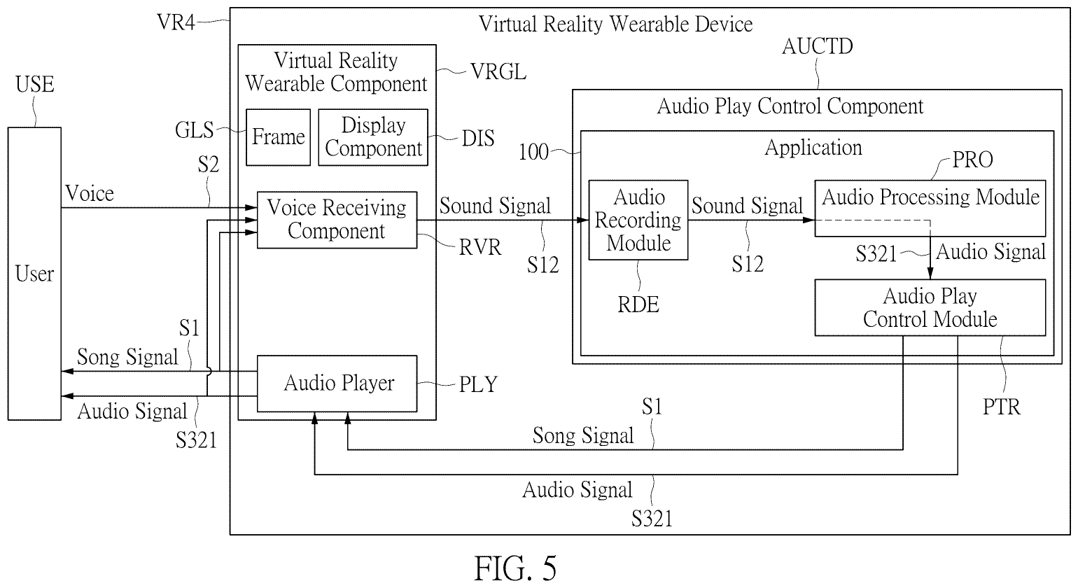

A virtual reality wearable device VR2 shown in FIG. 3 may be the same as the virtual reality wearable device VR1 shown in FIG. 2, a virtual reality wearable device VR3 shown in FIG. 4 or a virtual reality wearable device VR4 shown in FIG. 5.

When a user wears the virtual reality wearable device VR2 of the present disclosure, the user is able to listen the audio signal S321 played by the audio player PLY of the virtual reality wearable device VR2, and is able to watch information such as lyrics and related virtual images of the song signal S1 on the display component DIS of the virtual reality wearable device VR2. Accordingly, the virtual reality wearable device VR2 of the present disclosure is capable of providing excellent auditory and visual effects for the user.

Reference is made to FIG. 4, which is a block diagram of an audio processing system and a virtual reality wearable device having an audio processing mechanism according to a third embodiment of the present disclosure.

In the present disclosure, an application 100 may be installed on the audio play control component AUCTD included in the virtual reality wearable device VR3 having the audio processing mechanism. The application 100 is configured to perform all or some of the operations performed by the audio play control component AUCTD as described herein.

Reference is made to FIG. 5, which is a block diagram of an audio processing system and a virtual reality wearable device having an audio processing mechanism according to a fourth embodiment of the present disclosure.

In the fourth embodiment of the present disclosure, the virtual reality wearable device VR4 having the audio processing mechanism includes the virtual reality wearable component VRGL and the audio play control component AUCTD.

As shown in FIG. 5, in the fourth embodiment, the audio play control component AUCTD includes an audio play control module PTR, an audio processing module PRO and an audio recording module RDE. In practice, the audio recording module RDE may be omitted.

The application 100 may be installed on the virtual reality wearable device VR4 having the audio processing mechanism. The audio play control module PTR, the audio processing module PRO and the audio recording module RDE may be included in the application 100 of the audio play control component AUCTD that is a hardware component such as a processor.

For convenience of explanation, the application 100 is not described in the following. Operations that are performed by the audio play control module PTR, the audio processing module PRO and the audio recording module RDE are able to be performed by the application 100.

The audio recording module RDE of the audio play control component AUCTD is connected to the voice receiving component RVR of the virtual reality wearable component VRGL. In the audio play control component AUCTD, the audio processing module PRO is connected to the audio recording module RDE and the audio play control module PTR.

The audio play control module PTR of the audio play control component AUCTD is connected to the audio player PLY of the virtual reality wearable component VRGL.

The audio play control module PTR of the audio play control component AUCTD transmits the song signal S1 of the song ordered by the user USE (in step S101 of FIG. 7) to the audio player PLY of the virtual reality wearable component VRGL, and controls the audio player PLY to play the song signal S1 (in step S102 of FIG. 7).

The voice receiving component RVR of the virtual reality wearable component VRGL records the song signal S1, the voice S2 generated by the user USE and other sounds to generate the sound signal S12 (in step S103 of FIG. 7).

The audio recording module RDE of the audio play control component AUCTD may record or store the sound signal S12 from the voice receiving component RVR of the virtual reality wearable component VRGL.

The audio processing module PRO of the audio play control component AUCTD performs the above-mentioned operations that are performed by the audio play control component AUCTD on the sound signal S12 from the audio recording module RDE to output the audio signal S321 (in steps S104 and S105 of FIG. 7).

The audio play control module PTR of the audio play control component AUCTD transmits the audio signal S321 from the audio processing module PRO to the audio player PLY of the virtual reality wearable component VRGL, and controls the virtual reality wearable component VRGL to play the audio signal S321 (in step S106 of FIG. 7).

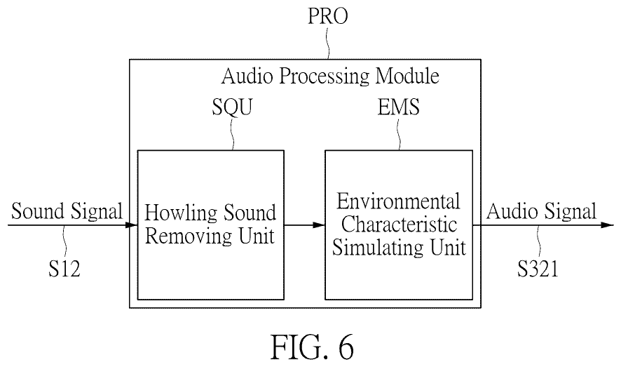

Reference is made to FIG. 6 and FIG. 7, in which FIG. 6 is a block diagram of an audio processing module of a virtual reality wearable device having an audio processing mechanism according to a fifth embodiment of the present disclosure, and FIG. 7 is a flowchart diagram of the virtual reality wearable device having the audio processing mechanism according to the fifth embodiment of the present disclosure.

The audio processing module PRO of the application 100 of the audio play control component AUCTD of the virtual reality wearable device VR4 shown in FIG. 5 may be the same as the audio processing module PRO shown in FIG. 6. As shown in FIG. 6, the audio processing module PRO includes a howling sound removing unit SQU and an environmental characteristic simulating unit EMS.

After steps S101 to S103 shown in FIG. 7 are performed as described above, steps S104 to S106 shown in FIG. 7 are sequentially performed, which is described in detail as follows.

The howling sound removing unit SQU performs the anti-howling sound algorithm on the sound signal S12 recorded by the voice receiving component RVR shown in FIG. 5 for removing the howling sound from the sound signal S12 shown in FIG. 5 (in step S104 of FIG. 7).

The environmental characteristic simulating unit EMS, based on a plurality of virtual environmental characteristics included in the information of the atmosphere of the virtual scene environment of the virtual image displayed on the display component DIS of the virtual reality wearable device VR4, sets a plurality of gains that includes the main audio gain, the echo gain, the reverberation gain and the audio entire gain as described above (in step S105 of FIG. 7).

Then, the environmental characteristic simulating unit EMS generates the audio signal S321 based on one of more of the plurality of gains such as the main audio gain, the echo gain, the reverberation gain and the audio entire gain as described above (in step S105 of FIG. 7). Then, the audio play control module PTR transmits the audio signal S321 from environmental characteristic simulating unit EMS to the audio player PLY, and the audio player PLY plays the audio signal S321 (in step S106 of FIG. 7). Therefore, the virtual reality wearable device VR4 of the present disclosure is capable of providing an in-ear-monitor (IEM) effect and an audio modulation effect for the user. This way, the user only needs to wear the virtual reality wearable device VR4 of the present disclosure, and not any headset.

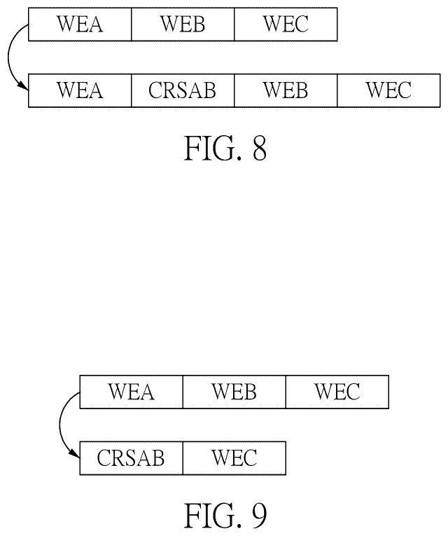

Reference is made to FIG. 8, which is a schematic diagram of waveform modulation of a sound signal generated by the virtual reality wearable device having the audio processing mechanism according to a sixth embodiment of the present disclosure.

The howling sound removing unit SQU may finely adjust a frequency of the sound signal S12, so that for human hearing, the howling sound is eliminated from the sound signal S12 and a change in pitch of the sound signal S12 is almost imperceptible. Therefore, the hearing experience of the user is not affected by the howling sound.

However, when the howling sound removing unit SQU finely adjusts the frequency of the sound signal S12 to output the audio signal S321, the speed that the audio signal S321 is played is unexpectedly adjusted. Therefore, after the howling sound is removed, the speed that the audio signal S321 is played must be adjusted back. Processes for adjusting the speed that the audio signal S321 includes a time domain adjustment process and a frequency domain adjustment process. Waveforms of the audio signal S321 are adjusted in different manners as exemplified in FIG. 8 and FIG. 9 for adjusting the speed of playing the sound signal S12, which is described in detail as follows.

In the present disclosure, (the howling sound removing unit SQU of the audio processing module PRO of) the audio play control component AUCTD of the virtual reality wearable device having the audio processing mechanism may perform a cross-fading algorithm for generating a waveform as a time domain waveform CRSAB according to a plurality of waveform characteristic values of at least two of the plurality of waveforms of the audio signal S321 such as two continuous waveforms WEA, WEB shown in FIG. 8. As shown in FIG. 8, the time domain waveform CRSAB is inserted between the two continuous waveforms WEA, WEB. The time domain waveform CRSAB includes at least some of the plurality of waveform characteristic values of the two continuous waveforms WEA and WEB.

The time domain waveform CRSAB has a complete period such that the time domain waveform CRSAB is smoothly connected to others of the plurality of waveforms of the audio signal S321.

In the sixth embodiment, only one the time domain waveform CRSAB is inserted between the two continuous waveforms WEA and WEB of the audio signal S321. In practice, more time domain waveforms may be inserted between the two continuous waveforms WEA, WEB of the plurality of waveforms of the audio signal S321, and one or more time domain waveforms may be inserted between others of the plurality of waveforms of the audio signal S321.

The howling sound removing unit SQU of the audio processing module PRO of the application 100 of the audio play control component AUCTD outputs the audio signal S321 including the time domain waveform CRSAB instead of the audio signal S321 that does not include the time domain waveform CRSAB. The audio player PLY of the virtual reality wearable component VRGL plays the audio signal S321 including the time domain waveform CRSAB. As a result, the waveforms that are generated later than the time domain waveform CRSAB in the audio signal S321 are delayed to be played so as to reduce the speed that the audio signal S321 is played.

Reference is made to FIG. 9, which is a schematic diagram of waveform modulation of a sound signal generated by the virtual reality wearable device having the audio processing mechanism according to a seventh embodiment of the present disclosure.

In the audio processing system of the present disclosure, the howling sound removing unit SQU of the audio processing module PRO of the audio play control component AUCTD may perform the cross-fading algorithm for generating the time domain waveform CRSAB according to the plurality of waveform characteristic values of at least two of the plurality of waveforms of the audio signal S321 such as the two continuous waveforms WEA, WEB shown in FIG. 9. In the audio signal S321, the waveforms WEA, WEB are replaced with the time domain waveform CRSAB as shown in FIG. 9. The time domain waveform CRSAB includes at least some of the plurality of waveform characteristic values of the two waveforms WEA and WEB.

The howling sound removing unit SQU of the audio processing module PRO of the audio play control component AUCTD outputs the audio signal S321 that includes the time domain waveform CRSAB, but not the waveforms WEA, WEB. The audio player PLY of the virtual reality wearable component VRGL plays the audio signal S321 that includes the time domain waveform CRSAB, but not the waveforms WEA, WEB. As a result, the waveforms that are generated later than the time domain waveform CRSAB in the audio signal S321 are played earlier so as to increase the speed that the audio signal S321 is played.

As described above, in the sixth and seventh embodiments, the time domain waveform CRSAB is inserted into the audio signal S321. In practice, the audio signal S321 at the time domain may be converted into the frequency spectrum at the frequency domain, and then processes the frequency spectrum, which is described in detail as follows.

The howling sound removing unit SQU of the audio processing module PRO of the audio play control component AUCTD converts the audio signal S321 at the time domain into the frequency spectrum at the frequency domain, captures a plurality of spectrum values from the frequency spectrum, and calculates a plurality of sound volume intensities according to the captured spectrum values. Then, the howling sound removing unit SQU samples some of the plurality of sound volume intensities, converts each of the plurality of sampled sound volume intensities into a plurality of volume sampled time-domain waveforms. Then, the howling sound removing unit SQU, according to the plurality of volume sampled time-domain waveforms, outputs the audio signal S321 to the audio player PLY for playing the audio signal S321.

Alternatively, the howling sound removing unit SQU converts the audio signal S321 at the time domain into the frequency spectrum at the frequency domain, captures the plurality of spectrum values from the frequency spectrum, and calculates a plurality of phases according to the captured spectrum values. Then, the howling sound removing unit SQU samples some of the plurality of phases, and converts each of the plurality of sampled phases at the frequency domain into a plurality of the phase sampled time domain waveforms at the time domain. Then, the howling sound removing unit SQU, according to the plurality of the phase sampled time domain waveforms, outputs the audio signal S321 to the audio player PLY for playing the audio signal S321.

When the audio signal S321 is converted from the time domain to the frequency domain and converted from the frequency domain to the time domain, a fast Fourier Transform (FFT) algorithm and an Inverse Fast Fourier Transform (IFFT) algorithm are performed. However, the fast Fourier Transform (FFT) algorithm and the Inverse Fast Fourier Transform (IFFT) are well known to those skilled in the art, and thus are not described herein.

It is worth noting that, an important technical feature of the present disclosure is that, the virtual reality wearable device of the present disclosure is capable of achieving the in-ear-monitor (IEM) effect and the audio modulation effect that are unable to be realized by conventional virtual reality wearable device in various applications.

In conclusion, the present disclosure provides the audio processing system and the virtual reality wearable device having the audio processing mechanism. The virtual reality wearable device of the present disclosure includes the virtual reality wearable component (such as the virtual reality glasses) and the audio processing system. The audio processing system of the present disclosure is capable of removing the howling sound that is noise for the user from the sound signal. When the user wears the virtual reality wearable device, the virtual reality wearable component plays the sound signal from which the howling sound is removed to the user, and the user is able to sing the song without noise interruption of the howling sound. Therefore, the virtual reality wearable device of the present disclosure is capable of achieving the in-ear-monitor (IEM) effect that is unable to be realized by the conventional virtual reality wearable devices. Therefore, the user only needs to wear the virtual reality wearable device of the present disclosure, but not additional headsets or other hardware components.

The audio processing system of the virtual reality wearable device of the present disclosure is able to perform the anti-howling sound algorithm for achieving the in-ear-monitor (IEM) effect.

In order to achieve the audio modulation effect, the audio processing system of the present disclosure removes the main audio signal that is generated by performing the audio modulation algorithm from the audio signal, and appropriately sets the echo gain used for the modulation of the echo signal and the reverberation gain used for the modulation of the reverberation signal. In order to solve the problem of excessive delay, the audio player and the voice receiving component of the virtual reality wearable device of the present disclosure are respectively the open built-in speaker and the open built-in microphone. When the user wears the virtual reality wearable device of the present disclosure and generates his own voice, the user is able to hear their own voice from the air. That is, the user does not hear the voice that is recorded and delayed to be played by the virtual reality wearable device of the present disclosure. Therefore, the user is able to get a good singing experience from the virtual reality wearable device of the present disclosure without wearing the headset.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An audio processing system, which is applicable to a virtual reality wearable component, comprising:
an audio play control component connected to the virtual reality wearable component, configured to control the virtual reality wearable component to play a song signal, and configured to control the virtual reality wearable component to record a sound signal when the song signal is played and a user generates a voice according to the song signal;
wherein the audio play control component is configured to remove howling sound from the sound signal to output an audio signal, and the virtual reality wearable component is configured to play the audio signal from the audio play control component.

2. The audio processing system according to claim 1, wherein an application is installed on the audio play control component.

3. The audio processing system according to claim 1, wherein the audio play control component is configured to:
use the sound signal from which the howling sound is removed as a main audio signal; and
generate an echo signal and a reverberation signal based on the main audio signal; and
output the audio signal according to the main audio signal, the echo signal and the reverberation signal.

4. The audio processing system according to claim 1, wherein the audio play control component is configured to:
use the sound signal from which the howling sound is removed as a main audio signal;
generate an echo signal and a reverberation signal based on the main audio signal;
multiply the echo signal by an echo gain to form an echo modulated signal; and
output the audio signal according to the main audio signal, the echo modulated signal and the reverberation signal.

5. The audio processing system according to claim 1, wherein the audio play control component is configured to:
use the sound signal from which the howling sound is removed as a main audio signal;
generate an echo signal and a reverberation signal based on the main audio signal;
multiply the main audio signal by a main audio gain to form a main audio modulated signal; and
output the audio signal according to the main audio modulated signal, the echo signal and the reverberation signal.

6. The audio processing system according to claim 1, wherein the audio play control component is configured to:
use the sound signal from which the howling sound is removed as a main audio signal;
generate an echo signal and a reverberation signal based on the main audio signal,
multiply the main audio signal by a main audio gain to form a main audio modulated signal;
multiply the echo signal by an echo gain to form an echo modulated signal; and
output the audio signal according to the main audio modulated signal, the echo modulated signal and the reverberation signal.

7. The audio processing system according to claim 1, wherein the audio play control component is configured to:
use the sound signal from which the howling sound is removed as a main audio signal;
generate an echo signal and a reverberation signal based on the main audio signal;
multiply the main audio signal by a main audio gain to form a main audio modulated signal;
multiply the echo signal by an echo gain to form an echo modulated signal;
multiply the reverberation signal by a reverberation gain to form a reverberation modulated signal; and
output the audio signal according to the main audio modulated signal, the echo modulated signal and the reverberation modulated signal.

8. The audio processing system according to claim 7, wherein the audio play control component is configured to:
synthesize the main audio modulated signal, the echo modulated signal and the reverberation modulated signal to form an audio synthesized signal; and
multiply the audio synthesized signal by an entire audio gain to output the audio signal.

9. The audio processing system according to claim 7, wherein both of the main audio gain and the echo gain are equal to 0.

10. The audio processing system according to claim 7, wherein both of the main audio gain and the echo gain are smaller than or equal to 0.5.

11. The audio processing system according to claim 1, wherein the audio play control component maintains sound volume of the audio signal at a preset value.

12. The audio processing system according to claim 1, wherein the audio play control component is configured to:
fine-tune a frequency of the sound signal for removing the howling sound from the sound signal;
convert the sound signal at a time domain into a frequency spectrum at a frequency domain;
capture a plurality of frequency spectrum values from the frequency spectrum;
calculate a plurality of phases according to the plurality of frequency spectrum values;
sample some of the plurality of phases as a plurality of sampled phases;
convert each of the plurality of sampled phases at the frequency domain into a plurality of phase sampled time domain waveforms at the time domain; and
output the audio signal to the virtual reality wearable component according to the plurality of phase sampled time domain waveforms.

13. A virtual reality wearable device having an audio processing mechanism, comprising:
a virtual reality wearable component; and
an audio play control component connected to the virtual reality wearable component, and configured to control the virtual reality wearable component to play a song signal;
wherein, when the audio play control component plays the song signal and a user generates a voice, the audio play control component controls the virtual reality wearable component to record a sound signal, the audio playback control component removes howling sound from the sound signal to output an audio signal, and the virtual reality wearable component plays the audio signal from the audio playback control component.

14. The virtual reality wearable device having the audio processing mechanism according to claim 13, wherein the audio playback control component is configured to:
use the sound signal from which the howling sound is removed as a main audio signal;
multiply the main audio signal by a main audio gain to form a main audio modulated signal;
generate an echo signal and a reverberation signal based on the main audio signal; and
output the audio signal according to the main audio modulated signal, the echo signal and the reverberation signal.

15. The virtual reality wearable device having the audio processing mechanism according to claim 13, wherein the audio playback control component is configured to:
use the sound signal from which the howling sound is removed as a main audio signal;
generate an echo signal and a reverberation signal based on the main audio signal,
multiply the main audio signal by a main audio gain to form a main audio modulated signal;
multiply the echo signal by an echo gain to form an echo modulated signal; and
output the audio signal according to the main audio modulated signal, the echo modulated signal and the reverberation signal.

16. The virtual reality wearable device having the audio processing mechanism according to claim 13, wherein the audio playback control component is configured to:
use the sound signal from which the howling sound is removed as a main audio signal;
generate an echo signal and a reverberation signal based on the main audio signal;
multiply the main audio signal by a main audio gain to form a main audio modulated signal;
multiply the echo signal by an echo gain to form an echo modulated signal;
multiply the reverberation signal by a reverberation gain to form a reverberation modulated signal; and
output the audio signal according to the main audio modulated signal, the echo modulated signal and the reverberation modulated signal.
